(19) United States
(12) Patent Application Publication
(10) Pub. No.: US 2022/0358158 A1
(43) Pub. Date: Nov. 10, 2022

(54) METHODS FOR SEARCHING IMAGES AND FOR INDEXING IMAGES, AND ELECTRONIC DEVICE

(71) Applicant: GUANGDONG OPPO MOBILE TELECOMMUNICATIONS CORP., LTD., Dongguan (CN)

(72) Inventors: Jenhao Hsiao, Palo Alto, CA (US); Jiawei Chen, Palo Alto, CA (US)

(21) Appl. No.: 17/869,600

(22) Filed: Jul. 20, 2022

Related U.S. Application Data
(63) Continuation of application No. PCT/CN2021/076072, filed on Feb. 8, 2021.
(60) Provisional application No. 62/975,565, filed on Feb. 12, 2020.

(51) Int. Cl. G06F 16/51; G06F 16/532; G06F 16/56

(52) U.S. Cl. CPC G06F 16/51; G06F 16/532; G06F 16/56

(57) ABSTRACT

A method for searching images is disclosed. The method includes obtaining a query keyword; and obtaining a target semantic embedding of the query keyword via a Semantics Aligning Network (SAN), and searching at least one target image corresponding to the query keyword according to the target semantic embedding via the SAN. The SAN is configured as a semantic embedding extractor and for providing a visual-semantics space, the visual-semantics space defines a mapping relationship between at least one image embedding and semantic embeddings, and each semantic embedding is generated based on a semantic constraint.

### CROSS-REFERENCE TO RELATED APPLICATION(S)

The present disclosure is a continuation of International (PCT) Patent Application No. PCT/CN2021/076072, filed on Feb. 8, 2021, which claims a priority to U.S. Provisional Patent Application, Ser. No. 62/975,565, filed on Feb. 12, 2020, the entire contents of both of which are herein incorporated by reference.

### TECHNICAL FIELD

The present disclosure generally relates to the technical field of image-processing, and in particular relates to a method for searching images, a method for indexing images, and an electronic device.

### BACKGROUND

The interest towards text-to-photo retrieval is increased due to the rapid growth of the photos generated by phone cameras. The need to efficiently find a desired image from a massive amount of photo is thus emerging.

### SUMMARY

According to one aspect of the present disclosure, a method for searching images is provided. The method includes obtaining a query keyword; and obtaining a target semantic embedding of the query keyword via a Semantics Aligning Network (SAN), and searching at least one target image corresponding to the query keyword according to the target semantic embedding via the SAN. The SAN is configured as a semantic embedding extractor and for providing a visual-semantics space, the visual-semantics space defines a mapping relationship between at least one image embedding and semantic embeddings, and each semantic embedding is generated based on a semantic constraint.

According to another aspect of the present disclosure, a method for indexing images is provided. The method includes obtaining at least one image; and converting the at least one image to at least one image embedding via a Semantics Aligning Network (SAN), such that a visual-semantics space is provided. The visual-semantics space defines a mapping relationship between the at least one image embedding and semantic embeddings, and each semantic embedding is generated based on a semantic constraint.

According to another aspect of the present disclosure, an electronic device is provided. The electronic device includes a processor and a memory storing instructions. The instructions when executed by the processor, causes the processor to perform the method as described in above aspects.

### BRIEF DESCRIPTION OF DRAWINGS

In order to make the technical solution described in the embodiments of the present disclosure more clearly, the drawings used for the description of the embodiments will be briefly described. Apparently, the drawings described below are only for illustration but not for limitation. It should be understood that, one skilled in the art may acquire other drawings based on these drawings, without making any inventive work.

FIG. 1 is a diagram of a framework of a Semantics Aligning Network (SAN) according to some embodiments of the present disclosure;

FIG. 2 is a flow chart of a method for searching images according to some embodiments of the present disclosure;

FIG. 3 is a list of top-ranked images obtained with query keyword is ‘lady’ based on the Semantics Aligning Network (SAN) according to some embodiments of the present disclosure;

FIG. 4 is a flow chart of a method for searching images according to another some embodiments of the present disclosure;

FIG. 5 is a flow chart of a method for indexing images according to some embodiments of the present disclosure;

FIG. 6 is a flow chart of a method for indexing images according to another some embodiments of the present disclosure;

FIG. 7 is a structural schematic view of an apparatus for searching images according to some embodiments of the present disclosure;

FIG. 8 is a structural schematic view of an apparatus for indexing images according to some embodiments of the present disclosure; and

FIG. 9 is a structural schematic view of an electronic device according to some embodiments of the present disclosure.

### DETAILED DESCRIPTION

The state-of-the-art works for text-to-photo retrieval mostly rely on encoding an image into an embedding vector that can align the visual space and the word space. However, relying on current word embedding could be problematic for a retrieval task since the existing word space is based on the word co-occurrence information in corpora instead of the semantic similarity among words. For example, in current word embedding, the words ‘lady’ and ‘man’ have higher cosine similarity to the word ‘adult’ than either to the word ‘adult’. Thus. using the keyword ‘lady’ to perform text-to-photo search based on the image vector learned from the current word embedding would lead to an unexpected result, which gives that the top-ranked images related to keyword ‘lady’ are undesired images for ‘man’.

To solve the above problems, the present disclosure provides a method for searching images, a method for indexing images, and an electronic device, which improves the deficiency of the current word vector and boosts the text-to-photo search accuracy by using a Semantics Aligning Network (SAN).

In order to facilitate the understanding of the present disclosure, the SAN according to embodiments of the present disclosure is first described in detail below.

Below embodiments of the disclosure will be described in detail, examples of which are shown in the accompanying drawings, in which the same or similar reference numerals have been used throughout to denote the same or similar elements or elements serving the same or similar functions. The embodiments described below with reference to the accompanying drawings are exemplary only, meaning they are intended to be illustrative of rather than limiting the present disclosure.

The SAN is configured as a semantic embedding extractor and for providing a visual-semantics space, the visual-semantics space defines a mapping relationship between at least one image embedding and semantic embeddings, and each semantic embedding is generated based on a semantic constraint.

The semantic constraint means a linguistic constraint, for example, a linguistic relation between words. A semantic embedding mapped to a certain image embedding is generated based on the semantic constraint. In other words, the linguistic constraint is injected into a word vector mapped to the image embedding. Thus, this can improve their usefulness for text-to photo search tasks.

In some embodiments, the semantic constraint can include a synonym relation and an antonym relation. A synonym relation means that one word or term is synonymous with another word or term, for example, ‘man’ and ‘adult’, ‘lady’ and ‘adult’. An antonym relation is one word is anonymous with another word, e.g., ‘man’ and ‘lady’.

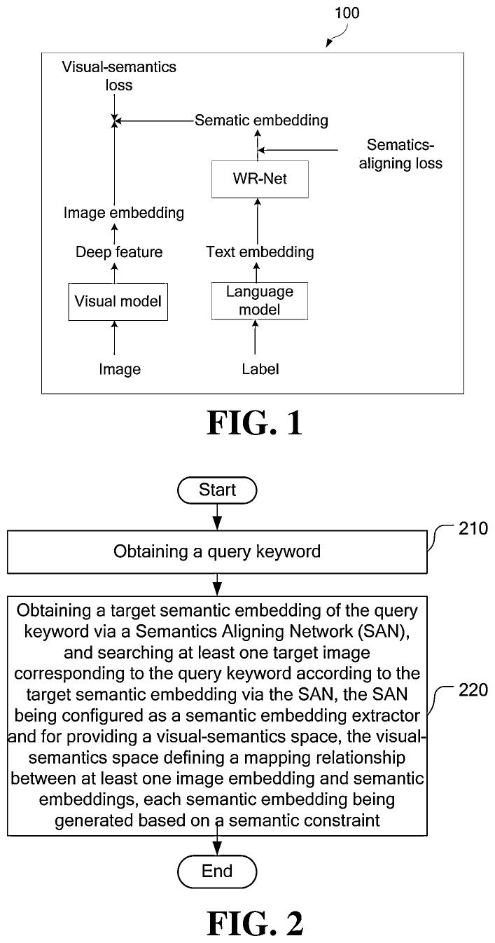

FIG. 1 is a diagram of a framework of a Semantics Aligning Network (SAN) according to some embodiments of the present disclosure. the SAN 100 includes a visual model, a language model, and a WordRefinement sub-network (WR-Net). The visual model may be configured for extracting features of at least one image and converting the features of the at least one image to the at least one image embedding. The language model may be configured for predicting a label of each of the at least one image to obtain a set of word vectors. The WordRefinement sub-network (WR-Net) may be configured for converting the set of word vectors to the semantic embeddings such that the semantic embedding extractor is achieved. Thus, a mapping relationship between image embeddings and semantic embeddings is generated.

The visual model may be configured for extracting features of at least one image and converting the features of the at least one image to the at least one image embedding. Specifically, the visual model may include a convolutional neural network (CNN). The convolutional neural network (e.g., ResNet) is used to serve as a feature extractor of an image. The convolutional neural network doesn't include a softmax prediction layer, and the convolutional neural network includes several convolutional filtering (with skip connections), batch normalization, and pooling layers followed by several fully connected neural network layers. The convolutional neural network is trained with a softmax output layer to predict one of 1,000 object categories from a dataset, for example, the ILSVRC 2012 1K dataset. The output of the last global-pooling-layer of the convolutional neural network is a 2048-dimensional vector, and is used to serve as an image embedding of the image. That is, the image embedding is CNN deep feature of the image.

The visual model may further include a core portion. The core portion of the visual model is trained to predict these semantic embedding for each image, by means of a projection layer and a similarity metric. The projection layer is a linear transformation that maps the 2048-dimensional deep vector into the same representation native to the language model.

The language model may be configured for predicting a label of each of the at least one image to obtain a set of word vectors. The language model may be a skip-gram text modeling architecture introduced by Mikolov. A label of each image may be an unannotated text or vocabulary. The unannotated text or vocabulary may include multiple words or terms.

The skip-gram text modeling architecture introduced by Mikolov has been shown to efficiently learn semantically meaningful floating-point representations of terms from unannotated text. The skip-gram text modeling architecture learns to represent each word or term as an embedding vector with a fixed length, by predicting adjacent terms in the unannotated text. These embedding vectors representations words vector, and also are called as text embeddings.

In an example of the skip-gram text modeling architecture introduced by Mikolov, a 300-dimensional word vector (i.e., text embedding) is created to represent each word or term.

The WordRefinement sub-network (WR-Net) may be configured for converting the set of word vectors to the semantic embeddings such that the semantic embedding extractor is achieved. Specifically, the WR-Net uses a synonym relation and an antonym relation drawn from either a general lexical resource or an application-specific ontology to fine-tune distributional word vectors.

The WR-Net may include two fully-connected layers, a batch normalization layer, and a ReLU. The WR-Net can be defined as:

WR(w)=M₂σ_{RELU}(BN(M₁w)).

where M₁ and M₂ are two fully-connected layers, BN(.) is the batch normalization layer, and σ_{RELU} is the activation functions of ReLU.

In some embodiments, a training of the SAN includes training the WR-Net according to a semantics-aligning loss resulted from the semantic constraint, such that the WR-Net is configured as the semantic embedding extractor, and training the visual model according to a visual-semantics loss, such that the visual-semantics space is provided.

As the WR-Net is trained according to a semantics-aligning loss resulted from the semantic constraint, and the visual model is trained according to a visual-semantics loss, thus, the whole SAN is trained. That is, to minimize the semantics-aligning Loss and the visual-semantics loss, Stochastic gradient descent (SGD) can be used to iteratively find the network parameters and train the whole network. Specifically, the WR-Net is trained individually until it converges, and then is frozen and used as the semantic embedding extractor. The visual-semantics loss is then used as the guidance to train the visual model such that the whole network is trained.

Further, in some examples, training the WR-Net includes adjusting the set of word vectors according to the semantics-aligning loss to generate another set of word vectors as the semantic embeddings.

Given that the set of word vectors W={w₁, w₂, . . . , wₙ} with one vector for each word in the text or vocabulary (i.e. the label). The semantic constraint, for example, the synonym relation and antonym relation, is injected into this vector space (i.e. the set of word vectors W) to produce another set of word vectors W′={w′₁, w′₂, . . . , w′ₙ} based on the semantics-aligning loss. The another set of word vectors W′ may also be called as a new semantically aligned word vectors or a new set of word vectors, and the set of word vectors W may be called as an original set of word vectors.

As described above, the semantic constraint can include a synonym relation and an antonym relation. Specifically, in some embodiments, the semantic constraint includes a first sub-constraint of word vectors of a pair of synonymous words being adjacent to each other in the another set of word vectors, a second sub-constraint of word vectors of a pair of antonymous words being spaced apart from each other in the another set of word vectors, and a third sub-constraint of the another set of word vectors preserving information contained in the set of word vectors.

In the first sub-constraint, the word vectors of a pair of synonymous words are brought closer together in the another set of word vectors W′. For example, the word vectors of the pair of synonymous words are adjacent to each other in the another set of word vectors W′.

In the second sub-constraint, the word vectors of a pair of synonymous words are pushed away from each other in the another set of word vectors W′. For example, word vectors of the pair of antonymous words are spaced apart from each other in the another set of word vectors W′.

In the third sub-constraint, the another set of word vectors preserves information contained in the set of word vectors. As the synonym and antonym relations are injected into the new representation (i.e. the set of word vectors W), the inferred word vector is needed to be close to the original word vector as much as possible. In this case, the another set of word vectors W′ needs to preserve information contained in the set of word vectors W. That is, the inferred word vectors preserve the information contained in the original word vectors.

Correspondingly, the semantics-aligning loss includes a synonym loss, an antonym loss, and a space loss, wherein the synonym loss is configured for achieving the first sub-constraint, the antonym loss is configured for achieving the second sub-constraint, and the space loss is configured for achieving the third sub-constraint.

In some examples, the semantics-aligning loss can be obtained as a predetermined operation is performed for the synonym loss, the antonym loss, and the space loss. For example, an adding operation is performed for the synonym loss, the antonym loss, and the space loss. Thus, the semantics-aligning loss may be a sum of the synonym loss, antonym loss, and space loss. For another example, a weighted sum operation is performed for the synonym loss, the antonym loss, and the space loss. Thus, the semantics-aligning loss can be a weighted sum of the synonym loss, the antonym loss, and the space loss, which is given as following.

SAL=α SynL(W′)+β AntL(W′)+γ SpaceL(W, W′)

where SAL is the semantics-aligning loss, SynL(W′) is the synonym loss, AntL(W′) is antonym loss, SpaceL(W, W′) is space loss, and α, β, and γ control the relative strengths of these losses.

In some examples, the synonym loss is indicated by a distance between the word vectors of the pair of synonymous words in a synonym set. Further, the synonym loss SynL(W′) is defined as:

SynL(W′)=−Σ_{(a,b)∈S}d(w′ₐ, w′_{b})

where d is the distance function, which use cosine similarity to evaluate pairs of synonymous words, a and b are a pair of synonymous words, S is a synonym set having pairs of synonymous words, w′ₐ and w′_{b} are word vectors of word a and word b in the another set of word vectors W′.

In some examples, the antonym loss is indicated by a difference between a distance between the word vectors of the pair of antonymous words in an antonym set and the minimum distance between antonymous words in the antonym set. Further, the antonym loss AntL(W′) is defined as:

AntL(W′)=Σ_{(a,b)∈A} max(d(w′ₐ, w′_{b})−m, 0)

where d is the distance function, which use cosine similarity to evaluate pairs of antonymous words, a and b are a pair of antonymous words, w′ₐ and w′_{b} are word vectors of word a and word b in the another set of word vectors W′, A is an antonym set having pairs of antonymous words, and m is the margin or minimum distance between antonymous words in the antonym set.

In some examples, the space loss is indicated by a distance between a word vector of a word in the set of word vectors and another word vector of the word in the another set of word vectors and a distance between the another word vector of the word in the another set of word vectors and a word vector of a neighbor of the word in the another set of word vectors.

Further, the space loss SpaceL(W, W′) is defined as:

SpaceL(W, W′)=−Σᵢ[d(w′ᵢ, wᵢ)+Σ_{j∈N(i)} d(w′ᵢ, w′ⱼ)]

where d is the distance function, d(w′ᵢ, wᵢ) is a distance between a word vector of word i in the set of word vectors W (i.e. original space or W space) and a word vector of word i in the another set of word vectors W′ (i.e. new space or W′ space), N(i) is neighbors of word i in the original space (i.e., W space), and d(w′ᵢ, w′ⱼ) is a distance between the word vector of word i in the another set of word vectors W′ and a word vector of a neighbor j of the word i in the another set of word vectors W′.

As described above, the visual model is trained according to the visual-semantics loss, such that the visual-semantics space is provided. As a combination of dot-product similarity and triplet loss are used for the semantics-aligning loss in some embodiments of the present disclosure, i.e. in the embodiments of the semantics-aligning loss can be a weighted sum of the synonym loss, the antonym loss, and the space loss, the visual model is trained to produce a higher dot-product similarity between an output of the visual model and the semantic embeddings of a correct label than between the output of the visual model and other randomly chosen words or terms.

Specifically, in some embodiments, the visual-semantics loss is indicated by a distance between a deep vector and each word vector in the set of word vectors and a distance between the deep vector and a word vector of ground-truth label. Further, the visual-semantics loss is defined for each training example as follow:

Visual-Semantics Loss=Σ_{j≠label} max(d(I, WR(wⱼ))−d(I, WR(w_{label}))+mᵥₛ, 0)

where I is the deep vector, d is the distance function, d(I, WR(wⱼ)) is a distance between the deep vector I and word vector wⱼ in the set of word vectors W, w_{label} is the word vector of ground-truth label, d(I, WR(w_{label})) is a distance between the deep vector I and a word vector w_{label} of ground-truth label, and mᵥₛ is the margin.

FIG. 2 is a flow chart of a method for searching images according to some embodiments of the present disclosure. The method may be performed by an electronic device, which includes, but is not limited to, a computer, a server, etc. The method includes actions/operations in the following blocks.

At block 210, the method obtains a query keyword.

The query keyword can be information contained in an image, for example, ‘man’, ‘lady’, ‘adult’, etc., or a location where the image was captured.

At block 220, the method obtains a target semantic embedding of the query keyword via a Semantics Aligning Network (SAN), and searching at least one target image corresponding to the query keyword according to the target semantic embedding via the SAN.

The SAN is configured as a semantic embedding extractor and for providing a visual-semantics space, the visual-semantics space defines a mapping relationship between at least one image embedding and semantic embeddings, and each semantic embedding is generated based on a semantic constraint.

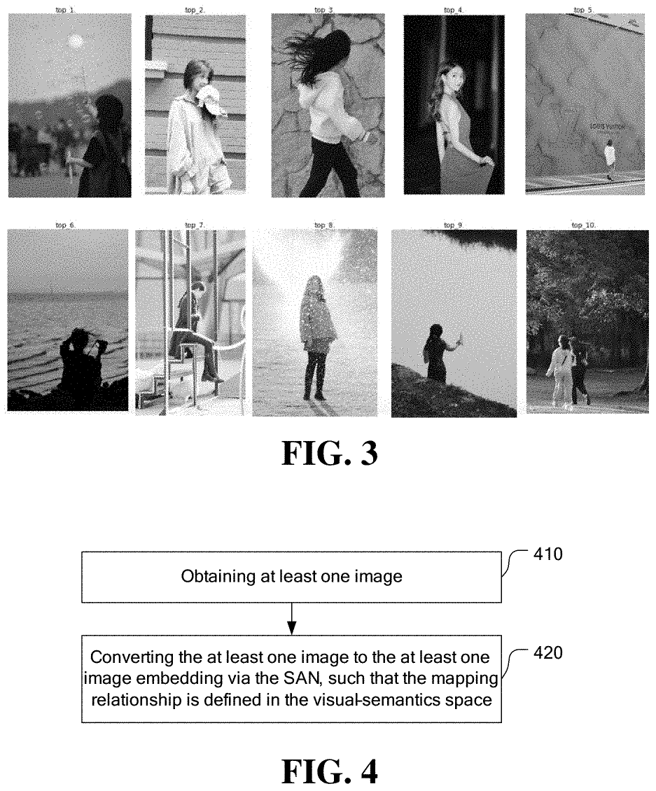

With the above SAN, the query keyword is input into the SAN to obtain the target semantic embedding of the query keyword, and the at least one target images corresponding to the query keyword is found according to the target semantic embedding in the visual-semantics space of the SAN. For example, when the query keyword is ‘lady’ with the above SAN, as shown in FIG. 3, the top-ranked images are all ‘lady’ images, instead of ‘man’ images, which shows a better vector representation to connect visual space and word space and more accurate result.

In these embodiments, with the SAN, which is configured as a semantic embedding extractor and for providing a visual-semantics space defining a mapping relationship between at least one image embedding and semantic embeddings, and each semantic embedding is generated based on a semantic constraint, the target semantic embedding of the query keyword is obtained, and at least one target images corresponding to the query keyword is found according to the target semantic embedding in the visual-semantics space of the SAN. Thus, this improves the deficiency of the current word vector and boosts the text-to-photo search accuracy.

In some embodiments, for obtaining a target semantic embedding of the query keyword at block 220, firstly, the query keyword is predicted via the language model to obtain a word vector of the query keyword, and then the word vector of the query keyword is converted to the target semantic embedding via the WR-Net.

As described above, at least one target image corresponding to the query keyword is found based on the target semantic embedding. In some examples, the at least one target image may be nearest images obtained based on the target semantic embedding in the visual-semantics space of the SAN, for example, images in ascending order of their respective distances from the target semantic embedding. That is, the at least one target image is images that is top-ranked in the visual-semantics space of the SAN. Further, the at least one target picture may include an image having a shortest distance with the target semantic embedding in the visual-semantics space.

FIG. 4 is a flow chart of a method for searching images according to another some embodiments of the present disclosure. The method may be performed by an electronic device, which includes, but is not limited to, a computer, a server, etc. Based on the above embodiments, the method further includes actions/operations in the following blocks.

At block 410, the method obtains at least one image.

At least one image can be obtained from the user's photo album in the electronic device, or it can be taken on site.

At block 420, the method converts the at least one image to the at least one image embedding via the SAN, such that the mapping relationship is defined in the visual-semantics space.

With the above SAN, the at least one image is input into the SAN and then converted to the at least one image embedding, such that the mapping relationship is defined in the visual-semantics space.

In these embodiments, with the SAN, which is configured as a semantic embedding extractor, at least one image is input into the SAN and then converted to the at least one image embedding, such that the mapping relationship is defined in the visual-semantics space. Thus, images are mapped to a finer semantic space, improving accurate indexing of images and then being helpful to boost the text-to-photo search accuracy.

In some embodiments, for converting the at least one image to the at least one image embedding via the SAN at block 420, firstly, deep features of the at least one image are obtained via the visual model of the SAN, and then the deep features of the at least one image are converted to the at least one image embedding.

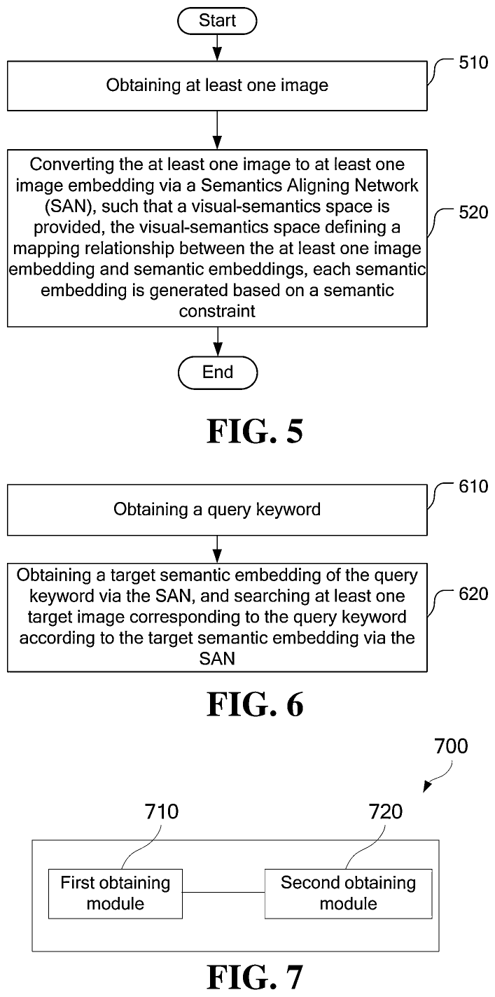

FIG. 5 is a flow chart of a method for indexing images according to some embodiments of the present disclosure. The method may be performed by an electronic device, which includes, but is not limited to, a computer, a server, etc. The method includes actions/operations in the following blocks.

At block 510, the method obtains at least one image.

At least one image can be obtained from the user's photo album in the electronic device, or it can be taken on site.

At block 520, the method converts the at least one image to the at least one image embedding via the SAN, such that the visual-semantics space is provided.

The visual-semantics space defines a mapping relationship between at least one image embedding and semantic embeddings, and each semantic embedding is generated based on a semantic constraint.

With the above SAN, the at least one image is input into the SAN and then converted to the at least one image embedding, such that the visual-semantics space is provided.

In these embodiments, with the SAN, which is configured as a semantic embedding extractor, at least one image is input into the SAN and then converted to the at least one image embedding, such that the mapping relationship is defined in the visual-semantics space. Thus, images are mapped to a finer semantic space, improving accurate indexing of images and then being helpful to boost the text-to-photo search accuracy.

In some embodiments, for converting the at least one image to the at least one image embedding via the SAN at block 520, firstly, deep features of the at least one image are obtained via the visual model of the SAN, and then the deep features of the at least one image are converted to the at least one image embedding.

FIG. 6 is a flow chart of a method for indexing images according to another some embodiments of the present disclosure. The method may be performed by an electronic device, which includes, but is not limited to, a computer, a server, etc. Based on the above embodiments, the method further includes actions/operations in the following blocks.

At block 610, the method obtains a query keyword.

The query keyword can be information contained in an image, for example, ‘man’, ‘lady’, ‘adult’, etc., or a location where the image was captured.

At block 620, the method obtains a target semantic embedding of the query keyword via a Semantics Aligning Network (SAN), and searching at least one target image corresponding to the query keyword according to the target semantic embedding via the SAN.

The SAN is configured as a semantic embedding extractor and for providing a visual-semantics space, the visual-semantics space defines a mapping relationship between at least one image embedding and semantic embeddings, and each semantic embedding is generated based on a semantic constraint.

With the above SAN, the query keyword is input into the SAN to obtain the target semantic embedding of the query keyword, and the at least one target images corresponding to the query keyword is found according to the target semantic embedding in the visual-semantics space of the SAN. For example, when the query keyword is ‘lady’ with the above SAN, as shown in FIG. 3, the top-ranked images are all ‘lady’ images, instead of ‘man’ images, which shows a better vector representation to connect visual space and word space and more accurate result.

In these embodiments, with the SAN, which is configured as a semantic embedding extractor and for providing a visual-semantics space defining a mapping relationship between at least one image embedding and semantic embeddings, and each semantic embedding is generated based on a semantic constraint, the target semantic embedding of the query keyword is obtained, and at least one target images corresponding to the query keyword is found according to the target semantic embedding in the visual-semantics space of the SAN. Thus, this improves the deficiency of the current word vector and boosts the text-to-photo search accuracy.

In some embodiments, for obtaining a target semantic embedding of the query keyword at block 620, firstly, the query keyword is predicted via the language model to obtain a word vector of the query keyword, and then the word vector of the query keyword is converted to the target semantic embedding via the WR-Net.

As described above, at least one target image corresponding to the query keyword is found based on the target semantic embedding. In some examples, the at least one target image may be nearest images obtained based on the target semantic embedding in the visual-semantics space of the SAN, for example, images in ascending order of their respective distances from the target semantic embedding. That is, the at least one target image is images that is top-ranked in the visual-semantics space of the SAN. Further, the at least one target picture may include an image having a shortest distance with the target semantic embedding in the visual-semantics space.

FIG. 7 is a structural schematic view of an apparatus for searching images according to some embodiments of the present disclosure. The apparatus 700 may include a first obtaining module 710 and a second obtaining module 720.

The first obtaining module 710 may be used to obtain query keyword. The second obtaining module 720 may be used to obtain a target semantic embedding of the query keyword via a Semantics Aligning Network (SAN), and search at least one target image corresponding to the query keyword according to the target semantic embedding via the SAN, wherein the SAN is configured as a semantic embedding extractor and for providing a visual-semantics space, the visual-semantics space defines a mapping relationship between at least one image embedding and semantic embeddings, and each semantic embedding being generated based on a semantic constraint.

It should be noted that, the above descriptions for the methods for searching image in the above embodiments, are also appropriate for the apparatus of the exemplary embodiments of the present disclosure, which will be not described herein.

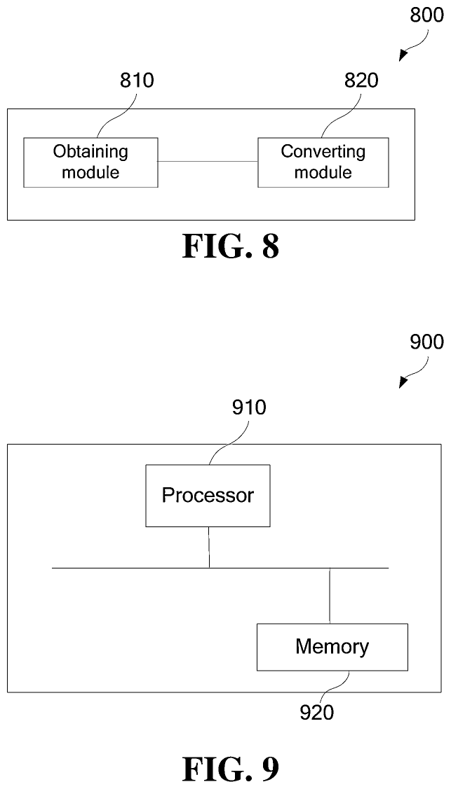

FIG. 8 is a structural schematic view of an apparatus for indexing images according to some embodiments of the present disclosure. The apparatus 800 may include an obtaining module 810 and a converting module 820.

The obtaining module 810 may be used to obtain at least one image. The converting module 820 may be used to convert the at least one image to at least one image embedding via a Semantics Aligning Network (SAN), such that a visual-semantics space is provided, the visual-semantics space defining a mapping relationship between the at least one image embedding and semantic embeddings, each semantic embedding is generated based on a semantic constraint.

It should be noted that, the above descriptions for the methods for searching image in the above embodiments, are also appropriate for the apparatus of the exemplary embodiments of the present disclosure, which will be not described herein.

FIG. 9 is a structural schematic view of an electronic device according to some embodiments of the present disclosure. The electronic device 900 may include a processor 910 and a memory 920, which are coupled together.

The memory 920 is configured to store executable program instructions. The processor 910 may be configured to read the executable program instructions stored in the memory 920 to implement a procedure corresponding to the executable program instructions, so as to perform any methods for searching images as described in the previous embodiments or a method provided with arbitrary and non-conflicting combination of the previous embodiments, or any methods for indexing images as described in the previous embodiments or a method provided with arbitrary and non-conflicting combination of the previous embodiments.

The electronic device 900 may be a computer, a sever, etc. in one example. The electronic device 900 may be a separate component integrated in a computer or a sever in another example.

A non-transitory computer-readable storage medium is provided, which may be in the memory 920. The non-transitory computer-readable storage medium stores instructions, when executed by a processor, causing the processor to perform the method as described in the previous embodiments.

A person of ordinary skill in the art may appreciate that, in combination with the examples described in the embodiments disclosed in this specification, units and algorithm steps may be implemented by electronic hardware, computer software, or a combination thereof. In order to clearly describe the interchangeability between the hardware and the software, the foregoing has generally described compositions and steps of every embodiment according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It can be clearly understood by a person skilled in the art that, for the purpose of convenient and brief description, for a detailed working process of the foregoing system, apparatus and unit, reference may be made to the corresponding process in the method embodiments, and the details will not be described herein again.

In the several embodiments provided in the present disclosure, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units herein may be selected according to the actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit are implemented in a form of a software functional unit and sold or used as an independent product, the integrated unit may be stored in a computer-readable storage medium. Based on such an understanding, the technical solutions of the present disclosure essentially, or the part contributing to the prior art, or all or a part of the technical solutions may be implemented in a form of software product. The computer software product is stored in a storage medium, for example, non-transitory computer-readable storage medium, and includes several instructions for instructing a computer device (which may be a personal computer, a server, or a network device) to perform all or a part of the steps of the methods described in the embodiments of the present disclosure. The foregoing storage medium includes any medium that can store program codes, such as a USB flash disk, a removable hard disk, a read-only memory (ROM), a random access memory (RAM), a magnetic disk, or an optical disk.

The foregoing descriptions are merely specific embodiments of the present disclosure, but are not intended to limit the protection scope of the present disclosure. Any equivalent modification or replacement figured out by a person skilled in the art within the technical scope of the present disclosure shall fall within the protection scope of the present disclosure. Therefore, the protection scope of the present disclosure shall be subject to the protection scope of the claims.

What is claimed is:

1. A method for searching images, comprising:
obtaining a query keyword; and
obtaining a target semantic embedding of the query keyword via a Semantics Aligning Network (SAN), and searching at least one target image corresponding to the query keyword according to the target semantic embedding via the SAN, the SAN being configured as a semantic embedding extractor and for providing a visual-semantics space, the visual-semantics space defining a mapping relationship between at least one image embedding and semantic embeddings, each semantic embedding being generated based on a semantic constraint.

2. The method of claim 1, wherein the SAN comprises:
a visual model, configured for extracting features of at least one image and converting the features of the at least one image to the at least one image embedding;
a language model, configured for predicting a label of each of the at least one image to obtain a set of word vectors; and
a WordRefinement sub-network (WR-Net), configured for converting the set of word vectors to the semantic embeddings such that the semantic embedding extractor is achieved.

3. The method of claim 2, wherein a training of the SAN comprises:
training the WR-Net according to a semantics-aligning loss resulted from the semantic constraint, such that the WR-Net is configured as the semantic embedding extractor; and
training the visual model according to a visual-semantics loss, such that the visual-semantics space is provided.

4. The method of claim 3, wherein the training the WR-Net comprises:
adjusting the set of word vectors according to the semantics-aligning loss to generate another set of word vectors as the semantic embeddings.

5. The method of claim 4, wherein the semantic constraint comprises a first sub-constraint of word vectors of a pair of synonymous words being adjacent to each other in the another set of word vectors, a second sub-constraint of word vectors of a pair of antonymous words being spaced apart from each other in the another set of word vectors, and a third sub-constraint of the another set of word vectors preserving information contained in the set of word vectors; and
the semantics-aligning loss comprises a synonym loss, an antonym loss, and a space loss, wherein the synonym loss is configured for achieving the first sub-constraint, the antonym loss is configured for achieving the second sub-constraint, and the space loss is configured for achieving the third sub-constraint.

6. The method of claim 5, wherein the synonym loss is indicated by a distance between the word vectors of the pair of synonymous words in a synonym set.

7. The method of claim 5, wherein the antonym loss is indicated by a difference between a distance between the word vectors of the pair of antonymous words in an antonym set and the minimum distance between antonymous words in the antonym set.

8. The method of claim 5, wherein the space loss is indicated by a distance between a word vector of a word in the set of word vectors and another word vector of the word in the another set of word vectors and a distance between the another word vector of the word in the another set of word vectors and a word vector of a neighbor of the word in the another set of word vectors.

9. The method of claim 3, wherein the visual-semantics loss is indicated by a distance between a deep vector and each word vector in the set of word vectors and a distance between the deep vector and a word vector of ground-truth label.

10. The method of claim 2, wherein the obtaining a target semantic embedding of the query keyword comprises:
predicting the query keyword via the language model to obtain a word vector of the query keyword; and
converting the word vector of the query keyword to the target semantic embedding via the WR-Net.

11. The method of claim 10, wherein the at least one target image comprises an image having a shortest distance with the target semantic embedding in the visual-semantics space.

12. The method of claim 2, further comprising:
obtaining at least one image; and
converting the at least one image to the at least one image embedding via the SAN, such that the mapping relationship is defined in the visual-semantics space.

13. The method of claim 12, wherein the converting the at least one image to the at least one image embedding via the SAN comprises:
obtaining deep features of the at least one image via the visual model; and
converting the deep features to the at least one image embedding.

14. A method for indexing images, comprising:
obtaining at least one image; and
converting the at least one image to at least one image embedding via a Semantics Aligning Network (SAN), such that a visual-semantics space is provided, the visual-semantics space defining a mapping relationship between the at least one image embedding and semantic embeddings, each semantic embedding is generated based on a semantic constraint.

15. The method of claim 14, wherein the SAN comprises:
a visual model, configured for extracting features of the at least one image and converting the features of the at least one image to the at least one image embedding;
a language model, configured for predicting a label of each of the at least one image to obtain a set of word vectors; and
a WordRefinement sub-network (WR-Net), configured for converting the set of word vectors to the semantic embeddings such that a semantic embedding extractor is achieved.

16. The method of claim 15, wherein a training of the SAN comprises:
training the WR-Net according to a semantics-aligning loss resulted from the semantic constraint, such that the WR-Net is configured as the semantic embedding extractor; and
training the visual model according to a visual-semantics loss, such that the visual-semantics space is provided.

17. The method of claim 16, wherein the training the WR-Net comprises:
adjusting the set of word vectors according to the semantics-aligning loss to generate another set of word vectors as the semantic embeddings.

18. The method of claim 17, wherein the semantic constraint comprises a first sub-constraint of word vectors of a pair of synonymous words being adjacent to each other in the another set of word vectors, a second sub-constraint of word vectors of a pair of antonymous words being spaced apart from each other in the another set of word vectors, and a third sub-constraint of the another set of word vectors preserving information contained in the set of word vectors; and
the semantics-aligning loss comprises a synonym loss, an antonym loss, and a space loss, wherein the synonym loss is configured for achieving the first sub-constraint, the antonym loss is configured for achieving the second sub-constraint, and the space loss is configured for achieving the third sub-constraint.

19. The method of claim 15, wherein the converting the at least one image to at least one image embedding comprises:
obtaining deep features of the at least one image via the visual model; and
converting the deep features to the at least one image embedding.

20. An electronic device, comprising a processor and a memory storing instructions;
wherein when the instructions are executed by the processor, the processor is caused to perform:
obtaining a query keyword; and
obtaining a target semantic embedding of the query keyword via a Semantics Aligning Network (SAN), and searching at least one target image corresponding to the query keyword according to the target semantic embedding via the SAN, the SAN being configured as a semantic embedding extractor and for providing a visual-semantics space, the visual-semantics space defining a mapping relationship between at least one image embedding and semantic embeddings, each semantic embedding being generated based on a semantic constraint; or
the processor is caused to perform:
obtaining at least one image; and
converting the at least one image to at least one image embedding via a Semantics Aligning Network (SAN), such that a visual-semantics space is provided, the visual-semantics space defining a mapping relationship between the at least one image embedding and semantic embeddings, each semantic embedding is generated based on a semantic constraint.
